(19) United States
(12) Patent Application Publication
(10) Pub. No.: US 2024/0005248 A1
(43) Pub. Date: Jan. 4, 2024

(54) METHODOLOGY AND TOOL FOR PROBABILISTIC RISK ASSESSMENT

(71) Applicant: North Carolina State University, Raleigh, NC (US)

(72) Inventors: Abhinav Gupta, Raleigh, NC (US); Saran Srikanth Bodda, Raleigh, NC (US); Pragya Vaishanav, Raleigh, NC (US)

(21) Appl. No.: 18/313,860

(22) Filed: May 8, 2023

Related U.S. Application Data
(60) Provisional application No. 63/340,333, filed on May 10, 2022.

(51) Int. Cl. G06Q 10/0635

(52) U.S. Cl. CPC G06Q 10/0635

(57) ABSTRACT

The present disclosure presents control systems and related methods for accurate estimation of a system-level risk. One such method comprises obtaining, via at least one of one or more computing devices, a tree data structure of a system-level failure risk of a system plant, wherein a binary state failure probability of an internal node in the tree data structure is a function of its logic gate connection and its child nodes; where the tree data structure has only independent nodes, computing a binary state failure probability of a failure event represented as a top node of the tree data structure; where the tree data structure has multiple dependent chains having a common dependent node, evaluating, the binary state failure probability of each dependent chain separately; and outputting the binary state failure probability for the failure event represented as the top node of the tree data structure.

### CROSS-REFERENCE TO RELATED APPLICATION

This application claims priority to co-pending U.S. provisional application entitled, “Methodology and Tool for Probabilistic Risk Assessment,” having Ser. No. 63/340,333, filed May 10, 2022, which is entirely incorporated herein by reference.

### STATEMENT REGARDING FEDERALLY SPONSORED RESEARCH OR DEVELOPMENT

The present invention was made with government support under grant number DE-AR0000976 awarded by the Advanced Research Projects Agency—Energy (DOE/ARPA-E). The United States Government has certain rights in the invention.

### BACKGROUND

Probabilistic risk assessment (PRA) is used as an essential tool for risk-informed regulation as well as risk-informed decision making in many industries, including involving the nuclear industry and power plants, among others. Existing PRA tools rely on using fault and event trees (logic trees) to estimate the probability of a system failure based on the failure probabilities of components as well as in identifying events that lie on a critical path. The fault trees or event trees for an actual power plant unit can be fairly large in size with several different types of logic gates, interconnected events, and dependent events, etc. A large fault tree can include hundreds of gates, basic events (BEs), multiple occurring events (MOEs), common cause failures, and dependent events. Complex connectivity between logic gates can give rise to excessive computational demand and storage requirement for the analysis. Fault and event trees can be solved using the minimal cut-set approaches, or advanced quantification techniques such as Binary decision diagrams or Bayesian networks. However, these techniques can be computationally inefficient for larger fault trees and can fail due to exhaustion of the available memory/storage space.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B respectively show a generic fault tree and a tree data structure in accordance with the present disclosure.

FIG. 2 provides a table (Table 1) showing truth tables for AND, OR, NAND, and NOR logic gates.

FIG. 3 shows a tree data structure with independent nodes.

FIG. 4 shows a tree data structure with one dependent node and single loop

FIG. 5A-5B illustrate the calculation of chain probabilities in accordance with the present disclosure.

FIG. 6 shows a general tree data structure with one dependent node and multiple chains.

FIGS. 7A-7B show an event tree and its corresponding fault trees for a simple example of the present disclosure.

FIGS. 8A-8C shows Venn diagrams illustrating probabilities of top events of accident sequence 2 (Seq₂) of FIG. 7A.

FIGS. 9A-9C show a tree data structure of accident sequence 2 (Seq₂) of FIG. 7A.

FIG. 10 shows a complex fault tree structure in accordance with the present disclosure.

FIG. 11 shows a tree data structure for the fault tree shown in FIG. 10.

FIGS. 12A-12C show the calculation of z for the dependent chains of FIG. 10.

FIGS. 13A-13C show a comparison of efficiency of an exemplary approach of the present disclosure with a traditional approach.

FIGS. 14A-14C show a comparison of accuracy of an exemplary approach of the present disclosure with a traditional approach.

FIG. 15 shows a typical fault tree structure used for a comparison of computational efficiency.

FIG. 16 shows a comparison of computational time between a traditional approach and an exemplary approach of the present disclosure for the fault tree structure in FIG. 15.

FIG. 17 is a block diagram illustrating an exemplary computing system or device that can be utilized for systems and methods of the present disclosure.

### DETAILED DESCRIPTION

The present disclosure relates to control systems and methods for accurate estimation of a system-level risk while improving the computational efficiency significantly. Accordingly, systems and methods of the present disclosure reduce the complexity for the analysis of multiple occurring events (MOEs) and dependent events in fault trees and present a significant improvement over traditional approaches. The computational efficiency over traditional approaches is illustrated using several different examples in the discussion that follows. Such systems and methods can be utilized in a variety of industries for risk assessments, including the aerospace and nuclear industries, among others.

For example, the nuclear industry has increased its reliance on probabilistic risk assessment (PRA) tools for design, operation, life extension, and regulation. PRA evaluates the risk associated with a specific hazard by a convolution of system fragility and hazard curves. A fragility curve of structures, systems, or components (SSCs) is expressed as the conditional probability of failure for a given hazard intensity and is a function of the uncertainties in empirical, experimental, and/or numerical data in the physical and mathematical models of the SSCs. U.S. Nuclear Regulatory Commission (USNRC) and International Atomic Energy Agency (IAEA) have issued guidelines for conducting a full scope PRA, where the plant level risk is calculated by combining the component and the subsystem fragility curves through a systems analysis. Typically, fault and event trees are used for conducting the systems analysis by logically combining the component level fragilities, and for convoluting the fragilities with the hazard curve.

Fault tree analysis is one of the most powerful tools in PRA to represent the failure probability of a nuclear plant based on the failure probabilities of its basic components. The events in fault and event trees are modeled using binary states: failure or not a failure (success). An assessment of logic trees with n events requires an analysis of 2ⁿ scenarios emerging from the various combinations of event failures. Hence, a complete analysis of a logic tree demands computational complexity of the order 2ⁿ in either time or space. The exponential order of complexity is required mainly to address the dependencies and dependent failure events.

Bottom-up methods have been used when fault trees do not include multiple occurring events (MOEs) and dependent events. However, a complex fault tree typically implements solvers such as a minimal cut set analysis. The computation of minimal cut sets for a fault and event tree is conducted through a widely used MOCUS (Method for Obtaining CUt Sets) algorithm. The computation of the minimal cut sets using this algorithm poses an intractable NP-hard problem. Therefore, the analysis of large fault trees requires significant computational resources, which makes the analysis of PRA models inefficient and time consuming. In addition, this approach may suffer from exponential complexity for computational time as a function of minimal cut sets in a network when exact computations need to be made. If the network consists of only the OR gates then the time complexity for exact computation would be O(2ⁿ^{_{BE}}), where n_{BE} is the number of basic events. Even with the advancements in available computational power, it is impractical to solve real-world problems using algorithms for which computational time increases exponentially with the increase in network size. Accordingly, the exponential complexity has been a major roadblock for performing the risk assessment accurately for a very long time.

In order to reduce the computational demands for the analysis of the fault and event tree networks, several assumptions or approximations are often relied upon. A brute force Monte Carlo simulation is used as an alternative when a large number of cut sets are likely to be present in the system model. Modularization techniques have been used for pre-processing of large fault trees, where the entire fault tree is divided into different modules that are solved independently. However, all the existing modularization methods are still not powerful enough to deal with a very large fault tree that contains several MOEs and dependent events. A binary decision diagram (BDD) is another established method where a fault tree is converted to a BDD structure based on the Boolean logic expression of the fault tree. However, the size of the BDD structure increases exponentially with the number of variables. Additionally, the size of the BDD structure is very sensitive to the order of variables. Therefore, excessive memory demand is an additional limitation for solving large fault trees with a BDD algorithm. Consequently, approximations are used and even with approximations, it results in polynomial order of computational complexity.

Recently, parallel processing techniques have been introduced in PRA that execute multiple critical processes simultaneously. This allows a reduction in the computational time and storage requirements for modularization, BDD, cut set dependency, and Monte Carlo simulations. However, the complexity inherent in traditional methods still remains intractable for large size problems. Bayesian networks have also been used for the analysis of the network diagrams. However, it appears that all formulations present some computational difficulties, which are due to either of the following reasons: (i) size of conditional probability tables, (ii) the size of clique potentials in the junction-tree algorithm, and (iii) the recursive algorithm for the identification of minimum link sets.

Computational efficiency of PRA has gained greater attention in recent years particularly after the Fukushima-Daiichi nuclear accident. There have been many studies focused on a multi-hazard PRA since then. For example, a seismically induced tsunami or hurricane induced wind and flooding scenarios have been studied quite widely. Prior to such studies, PRAs for individual hazards were conducted in isolation of each other. The fault and event tree network for each such single hazard is fairly large by itself. Consideration of multi-hazard scenarios has resulted in a single dependent initiating event which links the fault and event tree networks for individual hazards, thereby resulting in a very large network for combined hazards. The need for improvement in computational efficiency of PRAs is also desired in the context of new technologies such as the development of digital twins for autonomous control of advanced reactors. Such advanced autonomous systems have to rely on risk-informed decision making in real-time which requires running hundreds of scenarios in a relatively short amount of time to evaluate the best strategy for controlling the plant.

Traditionally, the response of a plant to an initiating external hazard is represented by an event tree. An event tree represents all the possible accident scenarios that will result in the failure of the plant. The frequency of the initiating external hazard is obtained from a hazard curve. The failure of each event in an event tree corresponds to the top event of a fault tree. A fault tree is a graphical decomposition of a top event failure into intermediate events (IEs) and basic events through the use of Boolean logic gates such as an AND & OR gates. Failure of a top event in a fault tree is evaluated by identifying the minimal cut sets. The minimal cut sets are a list of sets such that the failure of even a single set in the list would lead to the failure of the top event. A unique quality of minimal cut sets is that none of the cut sets in the list is a subset of another cut set. The quantification of top event failure probability using the minimal cut sets is performed in two steps.

A first step involves the calculation of individual minimal cut set probabilities, where an individual minimal cut set is connected by an AND gate to all the basic events in it. Hence, an individual minimal cut set probability is determined by multiplying the probabilities of all the basic events in it:

$$P ( {CS}_{i} ) = {\prod }_{j = 1}^{{n}_{i}} P ( {BE}_{j} ) \qquad ( 1 )$$

where P(CSᵢ) is the failure probability of minimal cut set CSᵢ, P(BEⱼ) is the failure probability of the j^{th} basic event in the i^{th} minimal cut set, and nᵢ is the number of basic events in the i^{th} minimal cut set.

In a second step, the minimal cut sets probabilities are combined to calculate the top event failure probability, P(TE). In current practice, three techniques are employed to find the probability for the union of the minimal cut sets, namely rare event approximation, minimal cut set upper bound, and min-max approach. The rare event approximation and minimal cut set upper bound are based on some approximations and provide conservative estimates. These approximations are often used to reduce the high computational cost that is otherwise needed to evaluate the exact probability. For most of the SSC failures in nuclear power plants, the approximate calculation of failure probabilities remains valid. The min-max approach based on the inclusion-exclusion rule leads to the most accurate quantification. However, it is employed only when the number of minimal cut sets are small, i.e., less than 50 in order to make the analysis computationally efficient. The formulations for the three techniques are summarized below:

Rare event approximation:

$$P ( TE ) = {\sum }_{i = 1}^{{n}_{mc}} P ( {CS}_{i} ) \qquad ( 2 )$$

Upper bound approximation:

$$P ( TE ) = 1 - {\prod }_{i = 1}^{{n}_{mc}} ( 1 - P ( {CS}_{i} ) ) \qquad ( 3 )$$

Min-max approach:

$$P ( TE ) {\sum }_{i = 1}^{{n}_{mc}} P ( {CS}_{i} ) - {\sum }_{i < j}^{{n}_{mc}} P ( {CS}_{i} ⋂ {CS}_{j} ) + {\sum }_{i < j < k}^{{n}_{mc}} P ( {CS}_{i} ⋂ {CS}_{j} ⋂ {CS}_{k} ) + … + {( - 1 )}^{{n}_{mc} - 1} P ( {{⋂}_{i = 1}}^{{n}_{mc}} {CS}_{i} ) \qquad ( 4 )$$

where n_{mc} is total number of minimal cut sets and P(CSᵢ) is the failure probability of the ith minimal cut set.

In a traditional PRA approach, importance measures provide a quantitative measure to identify the basic events that contribute the most to the top event failure probability. Some of the widely used importance measures in fault tree analysis are:
Risk Increase Ratio (RIR)—It is the increase (ratio or difference) in the top event failure probability when a basic event xⁱ is assumed to be completely failed.

$$Ratio \text{:} {RIR}_{{x}_{i}} = \frac{F ( 1 )}{F ( x )} \qquad ( 5 )$$

$$Interval : {RII}_{{x}_{i}} = F ( 1 ) - F ( x )$$

Risk Reduction Ratio (RRR)—It is defined as the decrease (ratio or difference) in the top event failure probability when a basic event xᵢ is assumed to be completely safe.

$$Ratio \text{:} {RRR}_{{x}_{i}} = \frac{F ( x )}{F ( 0 )} \qquad ( 6 )$$

$$Interval : {RRI}_{{x}_{i}} = F ( x ) - F ( 0 )$$

Birnbaum Importance (BI)—It represents the rate of change in the top event failure probability with respect to changes in the failure probability of a basic event.

BIₓ_{ᵢ}=F(1)−F(0) (7)
Fussell-Vesely (FV)—It measures the contribution of the basic event xᵢ to the top event failure probability.

$$\begin{matrix}{FV}_{{x}_{i}} = \frac{F ( i )}{F ( x )} \\ = 1 - \frac{1}{{RRR}_{{x}_{i}}}\end{matrix} \qquad ( 8 )$$

where F(1) denotes the failure probability of the top event when the basic event xᵢ probability is set to 1, F(0) denotes the failure probability of the top event when the basic event xᵢ probability is set to 0, F(i) denotes the top event probability from just the minimal cut sets that contain the basic event xᵢ, and F(x) denotes the top event failure probability without any modification in the basic event failure probability.

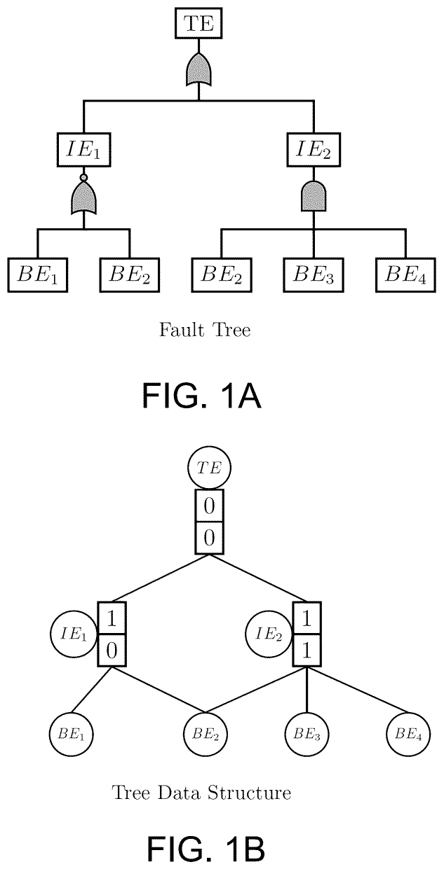

In accordance with the present disclosure, fault trees are represented using a general tree data structure. FIG. 1A shows a generic fault tree and FIG. 1B shows the corresponding general tree data structure. The following terminologies of the tree data structure are defined to assist with the explanation of the algorithms of the present disclosure.

Definitions and Terminology
Top/Root node—the top node in a tree data structure.
Child node—a node which is a descendant of any node. A node with no child nodes is called a leaf node.
Parent node—a node which is a predecessor of any node.
Internal node—a node which has at least one child node.
Edge—a link which connects any two nodes.
Chain/Path—a sequence of nodes and edges between two nodes.
Subtree—a part of tree data structure which represents a node and all of its descendants.
Height of a node—the total number of edges from a particular node to the leaf node in the longest chain. The height of all leaf nodes is zero.
Dependent/common node—a node which has more than one parent.
Independent tree—a tree with no dependent nodes.
Loop—a loop is formed when the start node and the end node of two chains are the same.
Logic Gate represents the parent/child relationship.
Nodes are represented by circles and the logic gates are denoted by rectangles. The basic event, intermediate event, and top event in the fault tree are referred to as leaf node, internal node, and top node in the tree data structure.

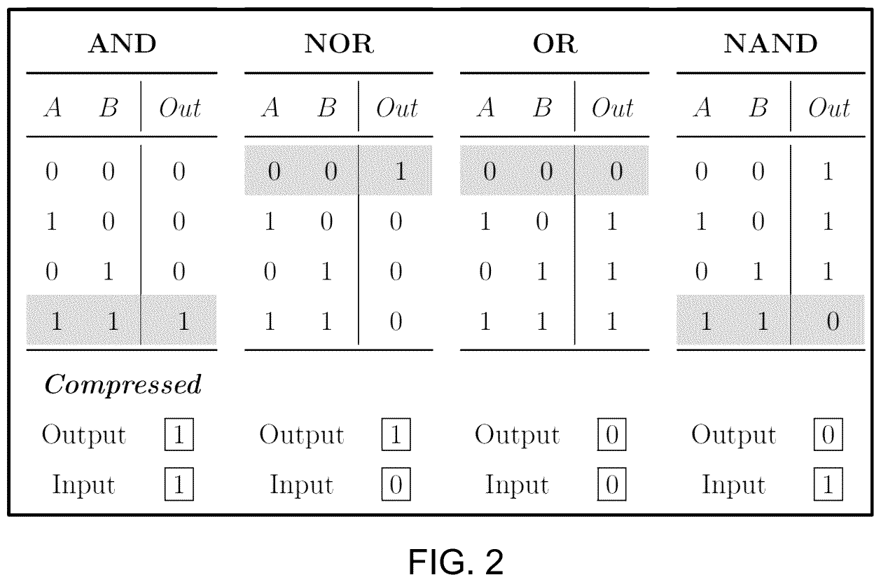

In a fault tree, all the intermediate events and the top event are connected to the basic events through the use of logic gates as shown in FIG. 1A. In a tree data structure, the logic gates represent the parent/child relationship, and all the internal nodes have the logic gate attribute. In the present disclosure, four logic gates are examined in detail: AND, OR, NAND, and NOR. Table 1 (FIG. 2) gives the truth tables for input nodes A and B when they are connected to an internal node with any of the four logic gates. In the truth tables, the failure and success states of a node are represented using binary states 1 and 0, respectively. The two binary states for nodes A and B lead to 4 (2²) possible combinations. If we suppose n nodes are connected to a logic gate, then there will be 2ⁿ possible combinations of input node states. As seen in Table 1 (FIG. 2), the highlighted output state is different from the output states of the rest of the three combinations in all the truth tables. This observation is valid even when n nodes are connected to a logic gate, i.e., the output state of only one of the combinations will be different from rest of the 2ⁿ−1 combinations.

Furthermore, the binary states of each logic gate are mutually exclusive and collectively exhaustive. Therefore, if the probability for the shaded output state (P_{Outputstate}) (FIG. 2) of a logic gate is calculated, then the probability for its complement state can be calculated as 1−P_{Outputstate}. In the present disclosure, the truth table for each logic gate is compressed in two states: an input state and an output state. Table 1 (FIG. 2) also shows the input state and output state for each logic gate in the tree data structure. The logic gates in the fault tree are converted into the input state and output state in the tree data structure and an illustration of the same can be seen in FIG. 1B.

The binary states probabilities of any internal node in a tree data structure can be calculated based on its logic gate and the probability of its child nodes. The output state and input state from the compressed truth table (Table 1 (FIG. 2)) are used to obtain these probabilities. The probabilities output state, P_{Out}(IN) and its complement state, P_{Out′}(IN) for an internal node are calculated using Eq. (9):

$$\begin{matrix}{P}_{Out} ( IN ) = {{⋂}_{i = 1}}^{{{n}_{c}}_{}} {P}_{Inp} ( {Child}_{i} ) \\ {P}_{{Out}^{′}} ( IN ) = 1 - {P}_{Out} ( IN )\end{matrix} \qquad ( 9 )$$

where Out and Inp are the output and input states of the logic gate corresponding to the internal node IN. Out′ is the complement of the output state; i.e., if Out=1 then Out′=0 . . . n_{c} is the total number of child nodes of the internal node IN. P_{Inp}(Childᵢ) is the probability of child i. Since all the nodes in the tree data structure are independent, the intersection of their failure or success state probabilities can be simply obtained by multiplying their respective probabilities as shown in Eq. (10):

$${P}_{Out} ( I N ) = {{⋂}_{i = 1}}^{{n}_{c}} {P}_{Inp} ( {Child}_{i} ) = {{\prod }_{i = 1}}^{{n}_{c}} {P}_{Inp} ( {Child}_{i} ) \qquad ( 10 )$$

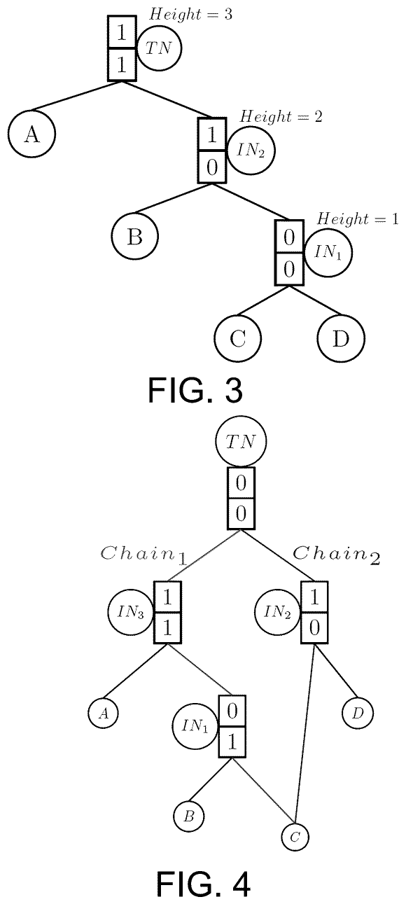

In the present disclosure, the failure probability of the top node is obtained using a bottom-up approach. The approach is illustrated for a simple tree data structure with independent nodes in FIG. 3. First, the height of all the internal nodes are calculated. In this example, the height of all the leaf nodes is zero, where the height of an internal node is calculated by counting the number of edges from the internal node to a leaf node along its longest chain. For example, there are three chains from internal node IN₂ to leaf nodes: IN₂-IN₁-C, IN₂-IN₁-D, IN₂-B, where the longest chain is IN₂-IN₁-C. Hence, the height of IN₂ is equal to 2. Similarly, heights of all the other nodes are calculated and all the internal nodes are sorted in ascending order based on the height as shown in FIG. 3. Next, the output probabilities of the internal nodes are calculated one by one in the sorted order [IN₁, IN₂, TN] as shown in Eq. (11) using Eq. (10):

P₀(IN₁)=P₀(C)×P₀(D),P₁(IN₁)=1−P₀(IN₁)

P₁(IN₂)=P₀(B)×P₀(IN₁),P₀(IN₂)=1−P₁(IN₂)

P₁(TN)=P₁(A)×P₀(IN₂),P₀(TN)=1−P₁(TN) (11)

where P₀ denotes the success probability of a node and P₁ denotes the failure probability of a node.

Accordingly, an exemplary algorithm (“Algorithm 1”) is presented to calculate the probabilities of all the independent nodes in a tree data structure. The required steps for obtaining the probabilities are described below:
1. Calculate the height of all internal nodes in the tree data structure.
2. Sort the internal nodes in ascending order based on their height.
3. Calculate the binary state probabilities (e.g. a binary state failure probability) of the first internal node in the sorted list based on its logic gate connection using Eq. (10).
4. Repeat step 3 for all the internal nodes in the sorted list.
5. In the final step, calculate the binary state probabilities of the top node based on its logic gate connection and Eq. (10).

Algorithm 1 is only valid for a tree data structure with independent nodes. When dependent or common nodes are present in a tree data structure, the intersection probabilities of node states can no longer be obtained simply by multiplying their respective probabilities as shown in Eq. (10). Therefore, in order to obtain the correct probability of the internal node, the intersection of its child nodes must be performed using Boolean algebra. In the present disclosure, we consider a tree data structure (see FIG. 4) with only one dependent node and a single loop to illustrate the process for calculating the exact probability of top node TN. The top node probability is calculated using Eq. (12):

$${P}_{Out} ( T N ) = {{⋂}_{i = 1}}^{{n}_{chains}} {P}_{Inp} ( {Chain}_{i} ) \qquad ( 12 )$$

where Out and Inp are the output and input states of the logic gate associated with the top node TN and Chainᵢ is the i^{th} dependent chain connected to the top node.

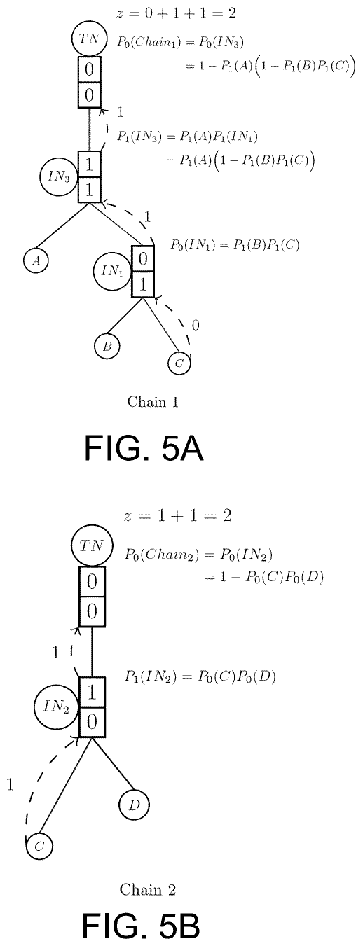

In FIG. 4, the two chains in the loop are: C—IN₁-IN₃-TN and C—IN₂-TN. The probability of each chain is evaluated separately. However, the probability is represented in terms of leaf nodes so that Boolean algebra of sets can be applied to calculate the exact probability. FIGS. 5A-5B illustrate the calculation of chain 1 (C—IN₁-IN₃-TN) and chain 2 (C—IN₂-TN) probabilities which are given in terms of leaf nodes and the final expressions are given by the following equations.

P₀(Chain₁)=1−P(A)×(1−P(BC))=1−P(A)+P(ABC)

P₀(Chain₂)=1−P(C′D′) (13)

Then, the top node probability is calculated by substituting Eq. (13) in Eq. (12):

$$\begin{matrix}{P}_{Out = 0} ( T N ) = {{⋂}_{i = 1}}^{2} {P}_{Inp = 0} ( {Chain}_{i} ) = {P}_{0} ( {Chain}_{1} ) \times {P}_{0} ( {Chain}_{2} ) \\ = ( 1 - P ( A ) + P ( ABC ) ) \times ( 1 - P ( {C}^{′} {D}^{′} ) ) \\ = 1 - P ( {C}^{′} {D}^{′} ) - P ( A ) + P ( A {C}^{′} {D}^{′} ) + \\ P ( ABC ) - P ( {ABCC}^{′} {D}^{′} ) \\ = 1 - P ( {C}^{′} {D}^{′} ) - P ( A ) + P ( A {C}^{′} {D}^{′} ) + P ( ABC ) \\ ( ∵ C ⋂ {C}^{′} = 0 )\end{matrix} \qquad ( 14 )$$

In this example, the Chain₁ and Chain₂ are dependent only on one common node C. Therefore, the intersection of chains can be performed simply in terms of the common dependent node C. Upon further examination of Eq. (13) in detail, we can see that the probabilities of the chains can be expressed as a linear function of the common node's failure probability and is given by Eq. (15):

$$\begin{matrix}{P}_{0} ( {Chain}_{1} ) = 1 - P ( A ) + P ( ABC ) = 1 - P ( A ) + P ( AB ) P ( C ) \\ = {k}_{{1}_{1}} + {k}_{{2}_{1}} P ( c ) \\ [ {k}_{{1}_{1}} = 1 - P ( A ) , {k}_{{2}_{1}} = P ( AB ) ]\end{matrix} \qquad ( 15 )$$

$$\begin{matrix}{P}_{0} ( {Chain}_{2} ) = 1 - P ( {C}^{′} {D}^{′} ) = 1 - P ( {D}^{′} ) \times \\ ( 1 - P ( C ) ) = 1 - P ( {D}^{′} ) + P ( {D}^{′} ) P ( C ) \\ = {k}_{{1}_{1}} + {k}_{{2}_{2}} P ( C ) \\ [ {k}_{{1}_{2}} = 1 - P ( {D}^{′} ) , {k}_{{2}_{2}} = P ( {D}^{′} ) ]\end{matrix}$$

where k₁_{ᵢ} and k₂_{ᵢ} are the coefficients of the linear expression for chain i's probability. Furthermore, the top node probability can also be expressed as a linear function of the common node's (C) failure probability and is given by Eq. (16):

$$\begin{matrix}{P}_{0} ( TN ) = ( {k}_{{1}_{1}} + {k}_{{2}_{1}} P ( C ) ) \times ( {k}_{{1}_{2}} + {k}_{{2}_{2}} P ( C ) ) \\ = {k}_{{1}_{1}} {k}_{{1}_{2}} + {k}_{{1}_{1}} {k}_{{2}_{2}} P ( C ) + {k}_{{1}_{2}} {k}_{{2}_{1}} P ( C ) + {k}_{{2}_{1}} {k}_{{2}_{2}} P ( CC ) \\ = {k}_{{1}_{1}} {k}_{{1}_{2}} + ( {k}_{{1}_{1}} {k}_{{2}_{2}} + {k}_{{1}_{2}} {k}_{{2}_{1}} + {k}_{{2}_{1}} {k}_{{2}_{2}} ) P ( C ) \\ ( ∵ C ⋂ C = C ) \\ = {K}_{1} + {K}_{2} P ( C ) \\ [ {K}_{1} = {k}_{{1}_{1}} {k}_{{1}_{2}} , {K}_{2} = {k}_{{1}_{1}} {k}_{{2}_{2}} + {k}_{{1}_{2}} {k}_{{2}_{1}} + {k}_{{2}_{1}} {k}_{{2}_{2}} ]\end{matrix} \qquad ( 16 )$$

where K₁ and K₂ are the coefficients of the linear expression for the top node (TN) probability.

In the present disclosure, a framework is provided to calculate the coefficients k₁_{ᵢ} and k₂_{ᵢ} for a given chain i which are later used to calculate the coefficients K₁ and K₂ for the top node.

As seen in Eq. (15) and FIGS. 5A-5B, k₂_{ᵢ} can be calculated by multiplying the probabilities of all the leaf nodes that are connected to the internal nodes along the chain i and is given by Eq. (17):

$${k}_{{2}_{i}} = {( - 1 )}^{z} {{\prod }_{j = 1}}^{{n}_{i}} {P}_{InpIN} ( {N}_{j} ) \qquad ( 17 )$$

where nᵢ is the total number of leaf nodes (except the common leaf node C) and other internal nodes connected to the internal nodes along the chain P_{InpIN}(Nⱼ) is the probability of the node Nⱼ and the state of the node (InpIN) is determined based on its connection to the logic gate associated with the internal node, z is the total number of state changes between a child node output state to its parent node input state along the chain. The input state of the common leaf node C is 1 (failure) and the estimation of z is illustrated in FIGS. 5A-5B using dashed arcs. Next, the term k₁_{ᵢ} is evaluated using Eq. (18):

k₁_{ᵢ}=P_{Ind}(Chainᵢ)−k₂_{ᵢ}P(C) (18)

where P_{Ind} (Chainᵢ) is the probability of chain i estimated using the algorithm for the tree data structure with independent nodes (see Eq. (13)).

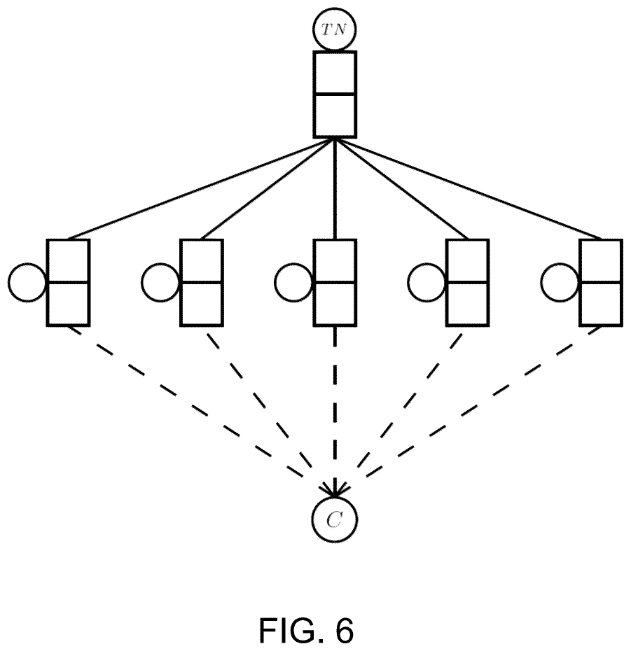

The framework presented for one dependent node with a single loop can be even extended to a loop with multiple chains in a tree data structure. This is illustrated for a general tree data structure shown in FIG. 6. If there are m chains in a loop with dependent node C, then the top node probability can be calculated exactly by considering the intersection between chains in terms of its dependent node C and is given by Eq. (19).

$$\begin{matrix}{P}_{O u t} ( T {N}_{d e p} ) = {{⋂}_{i = 1}}^{m} {P}_{Inp} ( {Chain}_{i} ) = P [ {{⋂}_{i = 1}}^{m} ( {k}_{{1}_{i}} + {k}_{{2}_{i}} C ) ] \\ = P [ {a}_{0} + {a}_{1} C + {a}_{2} {C}^{2} + … + {a}_{m} {C}^{m} ] \\ = {a}_{0} + ( {a}_{1} + {a}_{2} + … + {a}_{m} ) P ( C ) ( ∵ C ⋂ C = C ) \\ = {K}_{1} + {K}_{2} P ( C )\end{matrix} \qquad ( 19 )$$

where the polynomial coefficients a₀, . . . , aₘ can be obtained using Vieta's formula shown below:

$${a}_{m - l} = {( - 1 )}^{l - 1} {a}_{m} {\sum }_{1 \leq {i}_{1} < {i}_{2} < … < {i}_{l} \leq m} ( {\prod }_{j = 1}^{l} {r}_{{i}_{j}} )$$

$$for l = 1 , 2 , … , m ; {a}_{m} = {\prod }_{i = 1}^{m} {k}_{{2}_{i}} ; {r}_{{i}_{j}} = - \frac{{k}_{{1}_{j}}}{{k}_{{2}_{j}}}$$

In Eq. (19), Out and Inp are the output and input states of the logic gate associated with the top node TN, m is the number of chains, K₁=Πᵢ₌₁^{m}k₁_{ᵢ} and K₂=a₁+a₂+ . . . +aₘ.

As the estimation of K₂ involves a summation of 2^{m}−1 terms with various combination of coefficients, it can be computationally expensive as m increases. Therefore, the present disclosure presents an alternative approach to compute the coefficient K₂. The estimation of the probability of the top node without considering the intersection of the common node is given by Eq. (20):

$${P}_{Out} ( T {N}_{ind} ) {{⋂}_{i = 1}}^{m} ( {k}_{{1}_{i}} + {k}_{{2}_{i}} P ( C ) ) = {{\prod }_{i = 1}}^{m} ( {k}_{{1}_{i}} + {k}_{{2}_{i}} P ( C ) ) \qquad ( 20 )$$

The equation above is valid for various different values of P(C). One such condition is P(C)=1 in which case the probability of the top node estimated using dependent approach P_{Out}(TN_{dep}) is identical to that calculated using the independent approach P_{Out}(TN_{ind}). Therefore, K₂ can be calculated using Eq. (21).

$$∵ {P}_{Out} ( T {N}_{dep} ) = {P}_{Out} ( T {N}_{ind} ) ⟹ {K}_{1} + {K}_{2} ( 1 ) = {{\prod }_{i = 1}}^{m} ( {k}_{{1}_{i}} + {k}_{{2}_{i}} ( 1 ) ) ⟹ {K}_{2} = {{\prod }_{i = 1}}^{m} ( {k}_{{1}_{i}} + {k}_{{2}_{i}} ) - {K}_{1} \qquad ( 21 )$$

The required steps (Algorithm 2) for obtaining the probability of the top node when a tree data structure contains a dependent node with multiple chains is summarized below:
1. For each chain, calculate the coefficients k₂_{ᵢ} and k₁_{ᵢ} using Eq. (17) and Eq. (18), respectively.
2. Calculate coefficients K₁ and K₂ for the combined chains:

$${K}_{1} = {{\prod }_{i = 1}}^{m} {k}_{{1}_{i}} , {K}_{2} = {{\prod }_{i = 1}}^{m} ( {k}_{{1}_{i}} + {k}_{{2}_{i}} ) - {K}_{1} \qquad ( 22 )$$

3. Estimate the top node probability

P_{Out}(TN)=K₁+K₂P(C) (23)

Lastly, the provided algorithm (Algorithm 2) for a tree data structure with any number of dependent chains can be used to quantify the RIR, RRR, BI, and FV importance measures using Eq. (5), Eq. (6), Eq. (7), and Eq. (8), respectively. In order to calculate F(1) or F(0) in these equations, the basic events probabilities are set to 1 and 0 individually and the tree data structure is analyzed with the new set of probabilities.

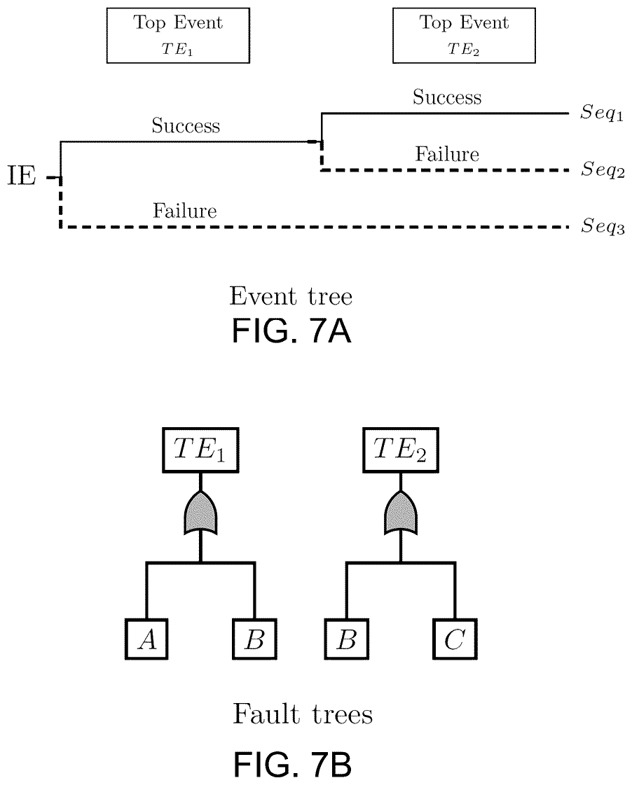

Next, in the present disclosure, a simple example of an event tree is taken to illustrate the accuracy of an exemplary approach of the present disclosure. Results obtained from an event tree analysis with the exemplary approach are compared to those from exact calculations based on set theory. FIGS. 7A-7B show an event tree with accident sequences and its corresponding fault trees of the two top events TE₁ and TE₂. The failure probabilities of the basic events A, B, and C are denoted by P₁ (A), P₁ (B), and P₁(C), respectively. In the event tree shown in FIG. 7A, sequence 2 (Seq₂) and sequence 3 (Seq₃) lead to unsafe conditions at the plant. For risk assessment, it would be important to calculate the risk associated with both the accident sequences, i.e. P(Seq₂) and P(Seq₃). In the present disclosure, Seq₂ is considered in order to compare the accuracy of the exemplary approach with exact calculations. Similarly, such a comparison for Seq₃ can also be performed. However, the comparison analysis for Seq₂ is not shown in this disclosure for brevity. For illustration purposes, the failure probability of basic events are chosen from the existing studies: P₁ (A)=0.125, P₁ (B)=0.08, and P₁(C)=0.2.

The exact failure probability of a sequence can be calculated by using the fundamental concepts of set theory. In general, a failure sequence k would contain a total of nₖ top events which can be decomposed into mₖ top events that exhibit “success” (or not a failure) and (nₖ−mₖ) top events that exhibit “failure.” The total probability of failure for a kth sequence can be expressed using Eq. (24).

$$P ( {Seq}_{k} ) = {{⋂}_{i = 1}}^{{m}_{k}} P ( T {E}_{i}^{′} ) {{⋂}_{j = {m}_{k} + 1}}^{{n}_{k}} P ( T {E}_{j} ) \qquad ( 24 )$$

where P(TEᵢ) and P(TE′ᵢ) represent the failure and the success of the i^{th} top event, respectively. The failure probability of Seq₂ shown in FIG. 7A is given by Eq. (25):

P(Seq₂)=P(TE′₁)∩P(TE₂) (25)

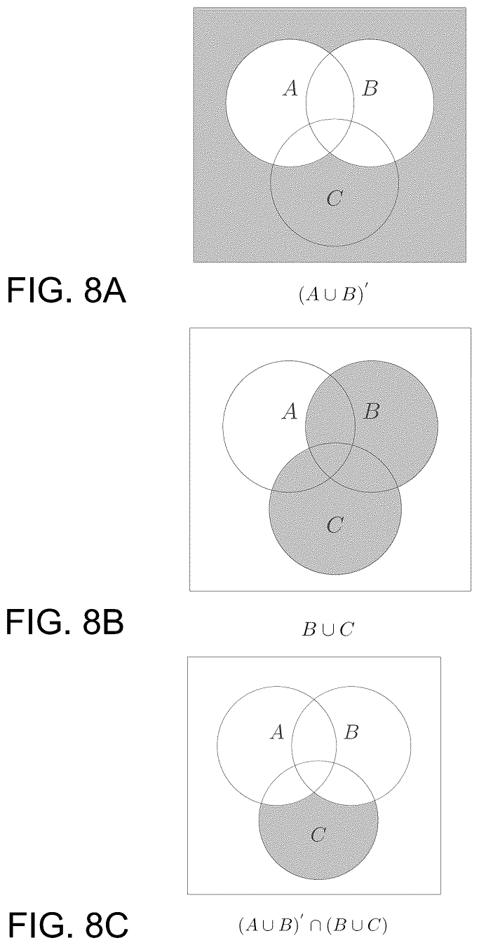

The calculation of probabilities of top events TE₁ and TE₂ in terms of basic events A, B, and C can be further illustrated through the use of Venn diagrams. FIGS. 8A-8C show the Venn diagrams for TE′₁, TE₂, and TE′₁∩TE₂.

The expression for Eq. (25) corresponding to accident sequence 2 can be written in terms of basic events (assuming A [symbol] B [symbol] C) and estimated using set theory as follows:

$$\begin{matrix}P ( {Seq}_{2} ) = {P ( A ⋃ B )}^{′} ⋂ P ( B ⋃ C ) \\ = P ( C ) - P ( C ⋂ A ) - P ( C ⋂ B ) + P ( A ⋂ B ⋂ C ) \\ = {P}_{1} ( C ) - {P}_{1} ( A ) {P}_{1} ( C ) - {P}_{1} ( B ) {P}_{1} ( C ) + \\ {P}_{1} ( A ) {P}_{1} ( B ) {P}_{1} ( C ) \\ = 0.2 - 0.2 \times 0.125 - 0.2 \times 0.08 + 0.2 \times 0.125 \times \\ 0.08 = 0.161\end{matrix} \qquad ( 26 )$$

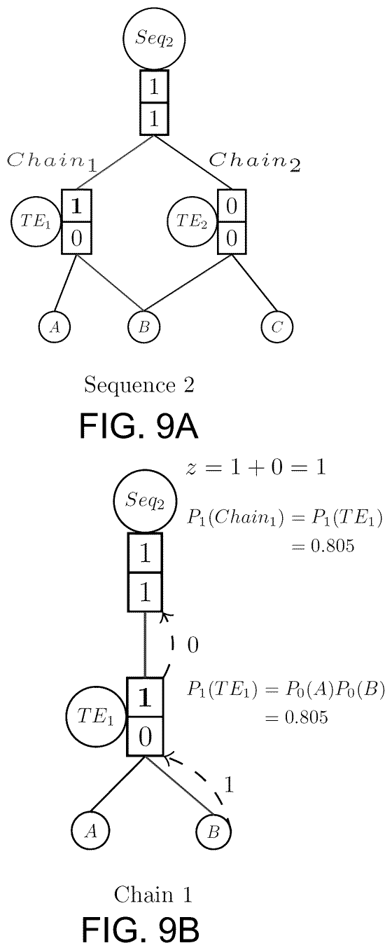

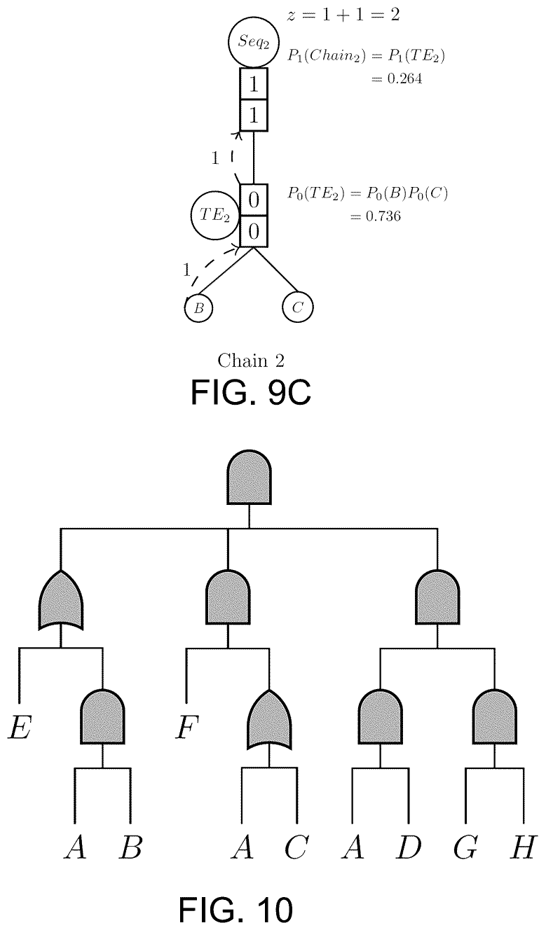

In order to use the exemplary approach, the accident sequence 2 shown in FIG. 7A is converted into a tree data structure as shown in FIG. 9A. The fault trees of all the top events in the accident sequence are connected to a new node with an AND logic gate, which gives the failure probability of the accident sequence. However, the output states of all the success top events in the accident sequence are modified with the complement of its original state. In this example, the original output state of the TE₁ is 0 (OR gate). As, TE₁ appears as a success event in the accident sequence 2, its output state is changed to 1 in the calculation of probability of the accident sequence.

The tree data structure shown in FIG. 9A has a loop with two chains (B-TE₁-Seq₂, B-TE₂-Seq₂) with a dependent node B. Next, Algorithm 2 is implemented to evaluate the accident sequence probability using the following steps:
Calculate the probability of chains using a bottom-up approach (Algorithm 1). The calculation for both the chains is illustrated in FIG. 9B and FIG. 9C. The obtained probability of the chains are: P₁ (Chain₁)=0.805; P₁ (Chain₂)=0.264.
Next, calculate coefficients k₂_{ᵢ} and for chain₁ using Eq. (17) and Eq. (18), respectively. The estimation of z is illustrated in FIG. 9B and FIG. 9C.
   Chain 1: k₂_{₁}=(−1)¹P₀(A)=−0.875; k₁_{₁}=P₁(Chain₁)−k₂_{₁}P₁(B)=0.875
   Chain 2: k₂_{₂}=(−1)²P₀(C)=0.8; k₁_{₂}=P₁(Chain₂)−k₂_{₂}P₁(B)=0.2
Calculate coefficients K₁ and K₂ for the combined chains using Eq. (22).

K₁=k₁_{₁}k₁_{₂}=0.175K₂=(k₁_{₁}+k₂_{₁})(k₁_{₂}+k₂_{₂})−K₁=−0.175
Finally, estimate the accident sequence probability with Eq. (27):

P₁(Seq₂)=K₁+K₂P(B)−0.161 (27)

A comparison between Eq. (26) and Eq. (27) shows that Algorithm 2 leads to an exact quantification of the probability of failure for a given accident sequence.

A relatively complex fault tree example is considered next to illustrate the application of Algorithm 2 for multiple chains with a dependent node. The fault tree shown in FIG. 10 consists of a basic event A that is common in three chains. Algorithm 2 can be applied to analyze this type of fault tree.

First, the fault tree is analyzed using the traditional algorithms to calculate the failure probability of the top event. Next, an exemplary approach of the present disclosure is used and results are compared with those obtained from traditional approach in order to illustrate the accuracy of the exemplary approach.

The fault tree shown in FIG. 10 consists of 7 intermediate events with their logic connection and 8 basic events. The probability of failure for all basic events are shown in Table 2 (below). The failure probabilities of the basic events have been chosen randomly for the illustration purpose. In Table 2 (below), P(1) and P(0) denotes the failure and the success probability of events.

TABLE 2

| | A | B | C | D | E | F | G | H |
|---|---|---|---|---|---|---|---|---|
| P(1) | 0.005 | 0.023 | 0.076 | 0.0039 | 0.0164 | 0.134 | 0.098 | 0.00754 |
| P(0) | 0.995 | 0.977 | 0.924 | 0.9961 | 0.9836 | 0.866 | 0.902 | 0.99246 |

In the traditional approach, the minimal cut sets are obtained first using the MOCUS algorithm. The MOCUS algorithm for the top event failure of the fault tree shown in FIG. 10 leads to two minimal cut sets: ABDFGH and ADEFGH. For a system such as that shown in FIG. 10, an exact failure probability can be calculated directly using min-max approach (Eq. (4)) without any computational approximation.

$$\begin{matrix}{P}_{1} ( T E ) = {{⋃}_{i = 1}}^{2} P ( {CS}_{i} ) = P ( ABDFGH ⋃ ADEFGH ) \\ = P ( ABDFGH ) + P ( ADEFGH ) - P ( ABDEFGH ) = \\ 7.5345 E - 11\end{matrix} \qquad ( 28 )$$

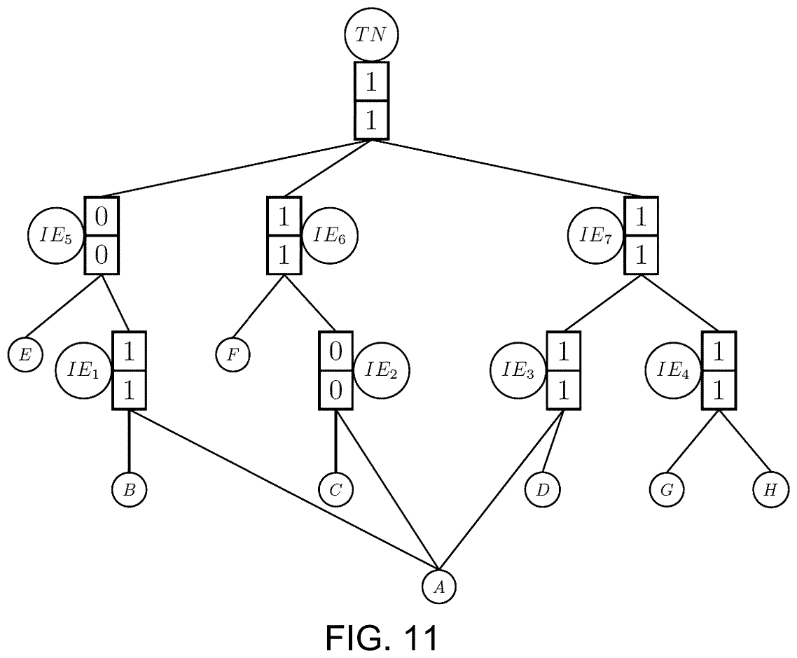

For an exemplary approach of the present disclosure, the fault tree shown in FIG. 10 is converted to the tree data structure using truth tables as shown in FIG. 11. The leaf node A is common to the three chains that converge at the top node.

First, all the dependent chains are analyzed separately using the algorithm (Algorithm 1) for independent nodes. The top node probability for each independent chain can be calculated as shown in Eq. (29).

P₁(Chain₁)=1−P₀(E)(1−P₁(B)P₁(A))=0.016513114

P₁(Chain₂)=P₁(F)(1−P₀(C)P₁(A))=0.01080308

P₁(Chain₃)=P(G)P(H)P(D)P(A)=1.44089E−08 (29)

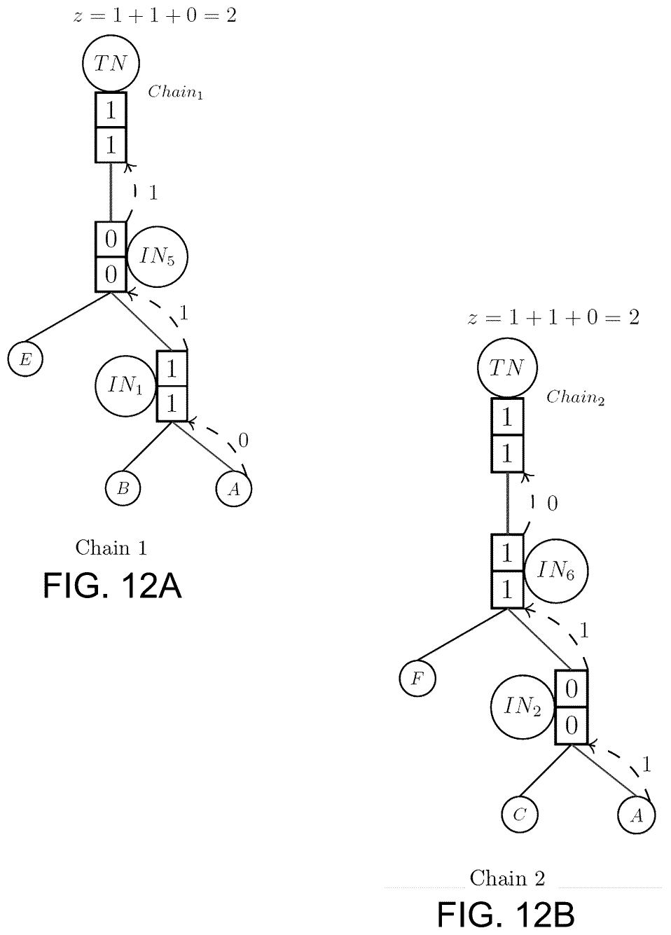

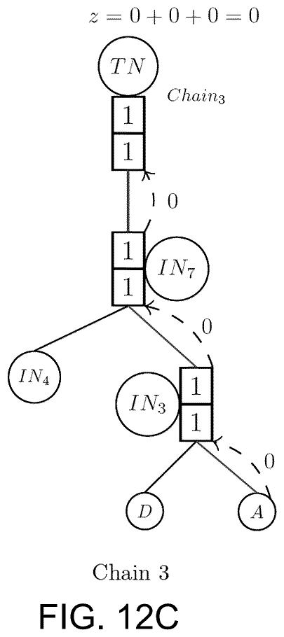

Second, using Algorithm 2, the coefficients k₁_{ᵢ} and k₂_{ᵢ} are calculated for i^{th} chain using Eq. (17) and Eq. (18), respectively. These values are listed in Table 3 (below). The calculation for the term z in the expression of k₂_{₁} in accordance with Eq. (17) is illustrated in FIGS. 12A-12C.

TABLE 3

| | Chain 1 | Chain 2 | Chain 3 |
|---|---|---|---|
| TN | 0.016513114 | 0.01080308 | 1.44089e−08 |
| k₂ | (−1)²P₀(E)P(B) | (−1)²P(F)P₀(C) | (−1)⁰[P(GH)]P(D) |
| | 0.0226228 | 0.123816 | 2.88179E−06 |
| k₁ = TN − k₂P(A) | 0.0164 | 0.010184 | 0 |
| k₁ + k₂ | 0.0390228 | 0.134 | 2.88179E−06 |

Finally, the top node probability for the output state can be calculated using Eq. (23). The top node failure probability calculated using the traditional approach and given in Eq. (28) is identical to that obtained using Algorithm 2.

$${P}_{1} ( T E ) = {K}_{1} + {K}_{2} {P}_{1} ( A ) = 7.53451 E - 11 \qquad ( 30 )$$

$$where : {K}_{1} = {{\prod }_{i = 1}}^{3} {k}_{{1}_{i}} = 0 , {K}_{2} = {{\prod }_{i = 1}}^{3} ( {k}_{{1}_{i}} + {k}_{{2}_{i}} ) - {K}_{1} = 1.5069 E - 08$$

Next, the tree data structure is analyzed for calculating the importance measures. Quantities, F(1) and F(0) are obtained by assuming the failure probability of basic events as 1 and 0, respectively. Algorithm 2 and the traditional approach leads to identical values of these quantities and thereby results in the exact quantification of various importance measures. The numerical values of various importance measures are shown in Table 4 (below).

TABLE 4

| Events | F(1) | F(0) | F(x) | RIR | RRR | FV | BI |
|---|---|---|---|---|---|---|---|
| A | 1.51E−08 | 0 | 7.53E−11 | 200 | inf | 1 | 1.51E-08 |
| B | 1.93E−09 | 3.17E−11 | 7.53E−11 | 25.6 | 2.4 | 0.58 | 1.90E-09 |
| C | 7.53E−11 | 7.53E−11 | 7.53E−11 | 1 | 1 | 0 | 0 |
| D | 1.93E−08 | 0 | 7.53E−11 | 256.4 | inf | 1 | 1.93E-08 |
| E | 1.93E−09 | 4.44E−11 | 7.53E−11 | 25.6 | 1.7 | 0.41 | 1.89E-09 |
| F | 5.62E−10 | 0 | 7.53E−11 | 7.5 | inf | 1 | 5.62E-10 |
| G | 7.69E−10 | 0 | 7.53E−11 | 10.2 | inf | 1 | 7.69E-10 |
| H | 9.99E−095 | 0 | 7.53E−11 | 132.6 | inf | 1 | 9.99E-09 |

The computational efficiency of an exemplary approach of the present disclosure is compared to that of a traditional approach. To do so, relatively larger sized fault trees are considered and run times are calculated for both approaches. At first, three sets of fault trees are considered. The geometric configuration of each set such as width, height, total number of events, number of basic events is kept constant. These details are provided in Table 5 (below). For a given geometric configuration, multiple fault tress cases can be generated by varying the connectivity and the type of gates. Each case will result in a different computation time.

TABLE 5

| Set no. | Width (no. of BEs) | Height | Total events | Total no. of cases |
|---|---|---|---|---|
| Set 1 | 34 | 6 | 44 | 10 |
| Set 2 | 117 | 6 | 132 | 10 |
| Set 3 | 70 | 11 | 90 | 20 |

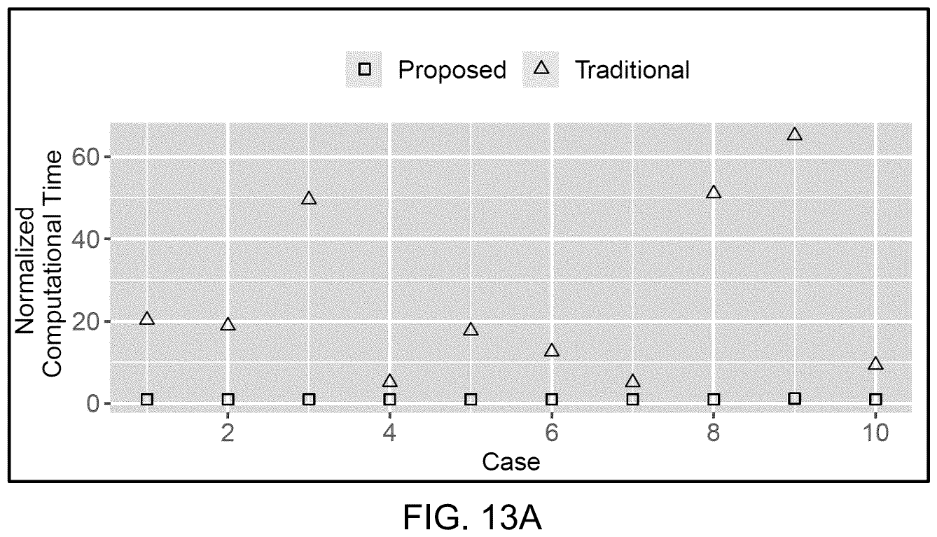

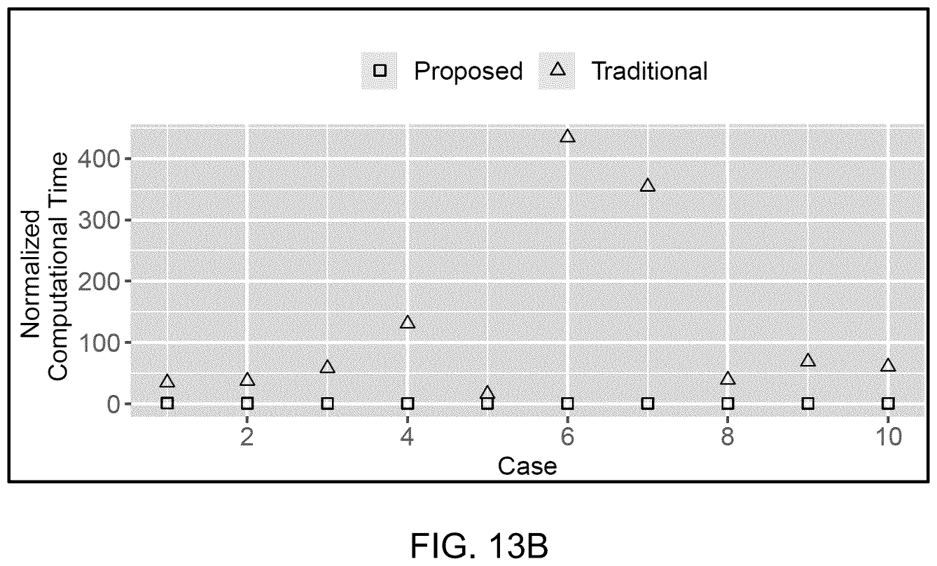

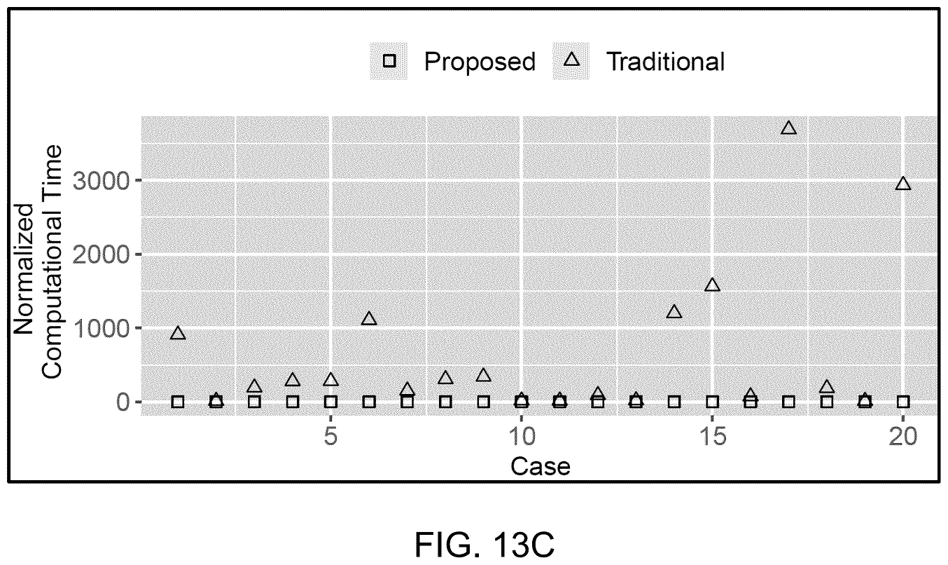

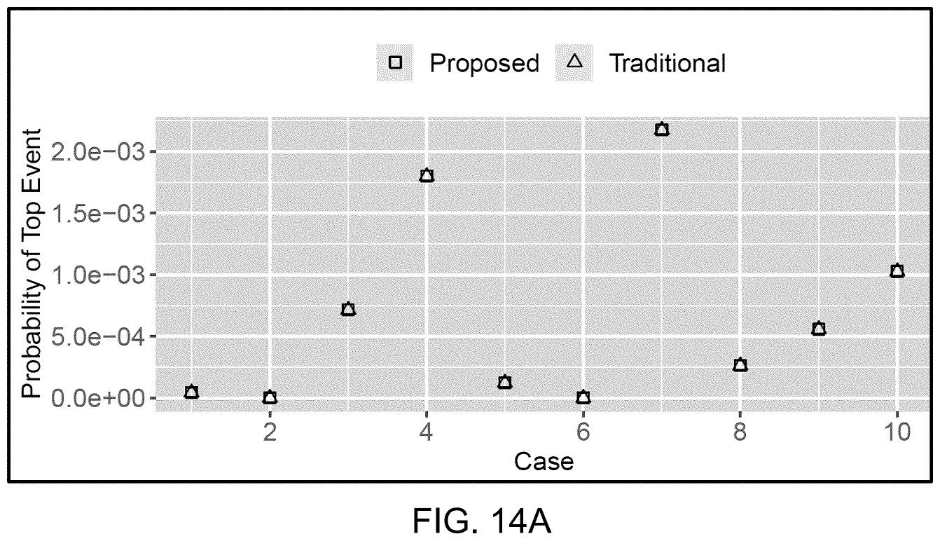

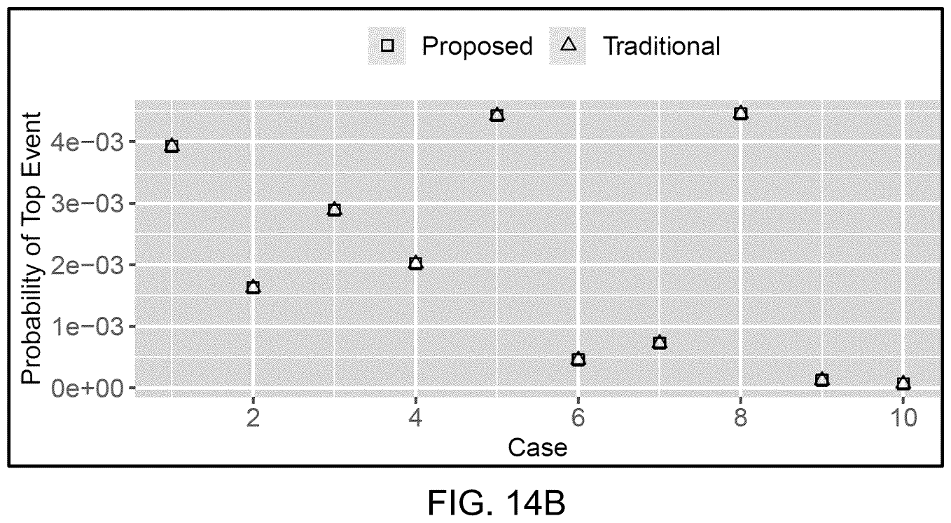

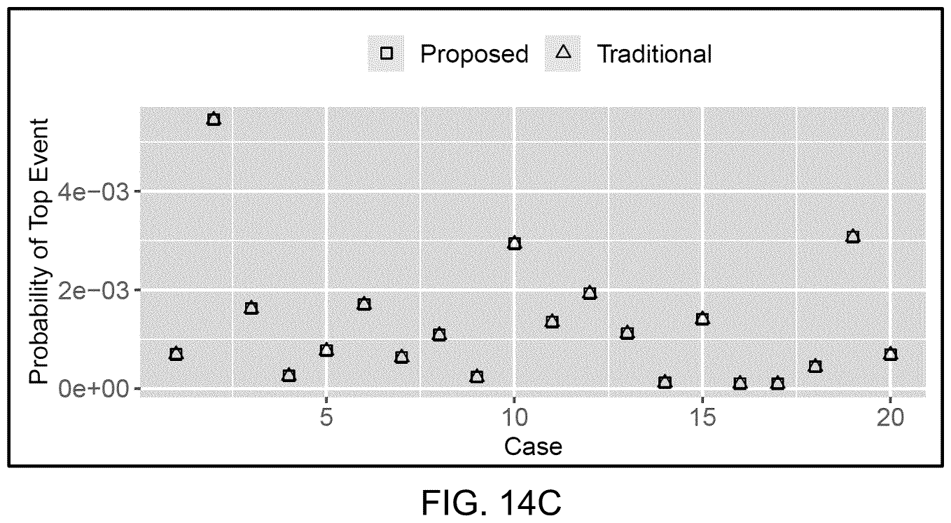

The fault trees considered here are analyzed with a traditional approach that utilizes MOCUS and upper bound approach, as discussed earlier. The true computation run time or CPU time is highly dependent upon the type of hardware used. Therefore, for a hardware independent comparison, run times are normalized with respect to the run time for the exemplary approach on the same hardware. This assists with visualization of relative difference in the computation times using the two approaches. The normalized run times for each case in the three sets are compared in FIGS. 13A-13C. As seen in FIGS. 13A-13C, the run times of the traditional approach can be significantly high in some cases depending upon the type and connectivity of different logic gates in the fault tree. An important aspect that is not directly evident in the figures is that the run time for the exemplary approach remains constant for various different cases of a given set. It changes from one set to another. In other words, unlike the traditional approach, the run time for the exemplary approach is not dependent upon the type of logic gates and their connectivity within a given fault tree. FIGS. 14A-14C compare the failure probability of top event for each case as evaluated from the two methods for the illustrating the accuracy of the exemplary approach. It is also important to note that for all cases and each set, the failure probabilities of top node are identical from the two approaches, as shown in FIGS. 14A-14C. In addition, the calculation for importance measures are also conducted for these fault trees. However, a comparison is not shown here for brevity.

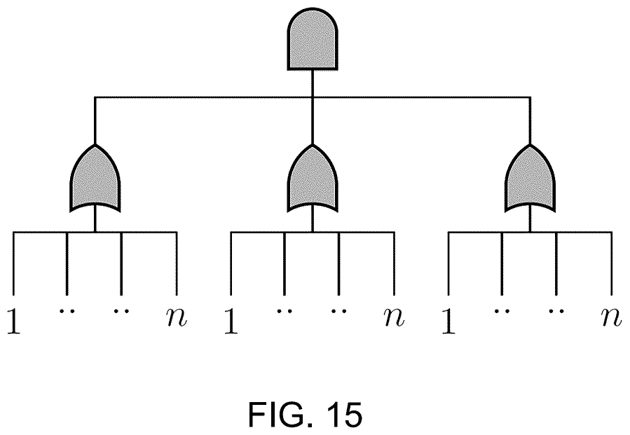

Next, a relative simpler case of connectivity and logic gate types is considered, but the size of fault trees is increased by increasing the number of basic events. FIG. 15 shows such a fault tree that consists of only three intermediate OR gates that are connected by an AND gate to give the top event. Each OR gate can be connected to multiple basic events. As the number of basic events increase, the computing run time increases. This example allows computation of exact values for failure probabilities of the top event without any reliance on an approximation of the min-max approach that has been used for traditional approaches in the previous examples described above. For such an example, the computational time is an exponential function of the number of minimal cut sets.

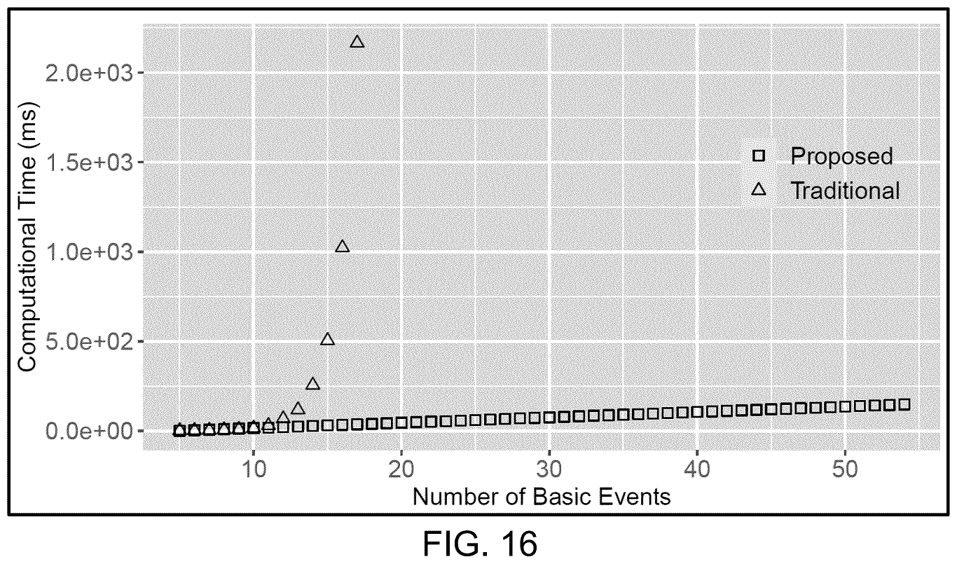

FIG. 16 compares the computational run time in millisecond (ms) from the two approaches and shows that the computational time for an exemplary approach of the present disclosure increases linearly whereas the computational time increases exponentially for the traditional approach. This comparison shows a significant improvement in the computational efficiency that can be achieved by an exemplary approach. The use of this approach for large fault and event tree networks can yield the analysis results with negligible computational efforts when compared with the computational demands of traditional approaches.

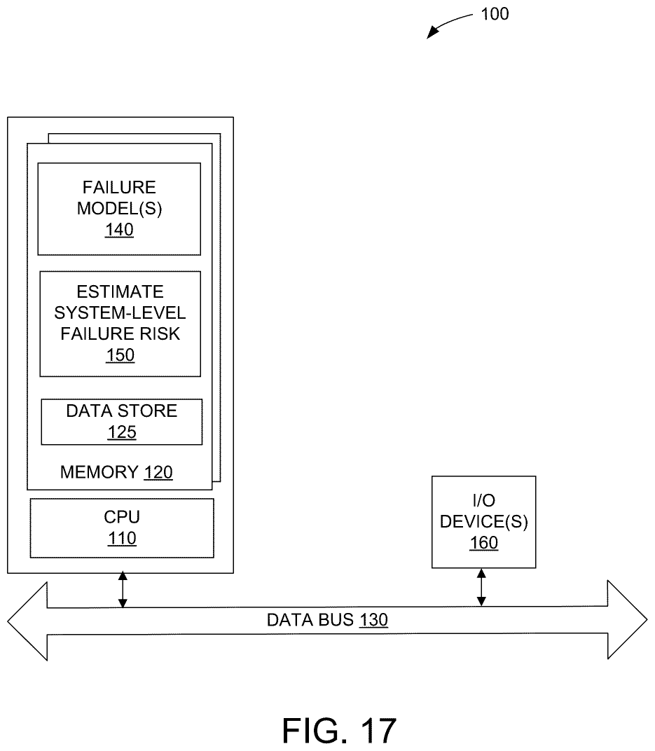

FIG. 17 is a block diagram illustrating an exemplary computing system or device 100 that can be utilized for systems and methods of the present disclosure. Computing system 100 includes at least one processor, e.g., a central processing unit (CPU), 110 coupled to memory elements 120 through a data bus 130 or other suitable circuitry. Computing system 100 stores program code or executable instructions within memory elements 120. Processor 110 executes the program code or instructions accessed from memory elements 120 via the data bus 130. In one aspect, computing system 100 may be implemented as a computer or other data processing system, including tablets, smartphones, or server computers that are accessed using browsers at client computers. It should be appreciated, however, that computing system 100 can be implemented in the form of any system including a processor and memory that is capable of performing the functions described within this disclosure.

Memory elements 120 include one or more physical memory devices such as, for example, a local memory and one or more storage devices. Local memory refers to random access memory (RAM) or other non-persistent memory device(s) generally used during actual execution of the program code. Storage device may be implemented as a hard disk drive (HDD), solid state drive (SSD), or other persistent data storage device. Computing system 100 may also include one or more cache memories (not shown) that provide temporary storage of at least some program code in order to reduce the number of times program code must be retrieved from storage device during execution.

Stored in the memory 120 are both data and several components that are executable by the processor 110. In particular, stored in the memory 120 and executable by the processor 110 are code for modelling component failures in a system plant (140) and code for estimating a risk of system-level failure using the failure models (150). Also stored in the memory 120 may be a data store 125 and other data. The data store 125 can include an electronic repository or database relevant to fault and event tree analysis of the modeling components. In addition, an operating system may be stored in the memory 120 and executable by the processor 110. In an embodiment, predictive model data are stored in the data store 125, such as model parameters.

Input/output (I/O) devices 160 such as a keyboard, a display device, and a pointing device may optionally be coupled to computing system 100. The I/O devices may be coupled to computing system 100 either directly or through intervening I/O controllers. A network adapter may also be coupled to computing system to enable computing system to become coupled to other systems, computer systems, remote printers, and/or remote storage devices through intervening private or public networks. Modems, cable modems, Ethernet cards, and wireless transceivers are examples of different types of network adapter that may be used with computing system 100.

Certain embodiments of the present disclosure can be implemented in hardware, software, firmware, or a combination thereof. If implemented in software, such logic or functionality of the present disclosure can be implemented in software or firmware that is stored in a memory and that is executed by a suitable instruction execution system. If implemented in hardware, such logic or functionality can be implemented with any or a combination of the following technologies, which are all well known in the art: discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Thus, one or more components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as, magnetic, optical, semiconductor, or other suitable media. Examples of a suitable computer-readable media include, but are not limited to, solid-state drives, magnetic drives, flash memory. Further, any logic or component described herein can be implemented and structured in a variety of ways. One or more components described can be implemented as modules or components of a single application. Further, one or more components described herein can be executed in one computing device or by using multiple computing devices.

In summary, fault and event trees are used for probabilistic risk assessment in various industries, that include nuclear power plant systems, among others. A fault and even trees analysis for a power plant requires modelling of hundreds of component failures, logic gates, multiple occurring events, and dependent events. Such interconnection for large networks can lead to excessive computational demand. Most of the traditional methods address computational demand by using assumptions or relying on high performance computing facilities that allow implementations of parallel computing. The present disclosure presents a novel module-based approach to address the computational demands of PRA. An exemplary approach is developed for fault trees with a dependent node and multiple chains connecting the dependent node. The logic gates are converted into compressed truth tables to achieve the desired efficiency.

Two types of fault tree configurations are used to illustrate the computational efficiency of an exemplary approach of the present disclosure. First, fault trees with a same number of basic events and intermediate events are considered, i.e., fault trees with a fixed height and width. For such fault trees, the computational demand of traditional approaches changes based on different connectivity of events and gates. However, the computational demand of the exemplary approach remains constant. In addition, the computational demand of the exemplary approach can be less than that of a traditional approach by an order of magnitude for some cases. Second, fault trees with a fixed height and fixed logic gates (intermediate events) but varying widths are considered by increasing the number of basic events. For such trees, it is illustrated that the computational demand of the exemplary approach increases at a rate that is less than a linear function of the number of basic events. In contrast, the computational demand of traditional approach increases exponentially as O(2ⁿ). It is also shown that an exemplary approach gives identical results to those obtained by the traditional approach, and for a simple case, identical to that calculated using fundamental concepts of set theory. In brief, the exemplary approach is computationally efficient and has the same accuracy as traditional approaches. It can also be used to calculate the various importance measures correctly. However, the exemplary approach is different from traditional approaches in the sense that it does not calculate minimal cut sets. Accordingly, the exemplary approach of the present disclosure is a significant improvement over the currently available techniques.

It should be emphasized that the above-described embodiments of the present disclosure are merely possible examples of implementations, merely set forth for a clear understanding of the principles of the disclosure. Many variations and modifications may be made to the above-described embodiment(s) without departing substantially from the principles of the disclosure. All such modifications and variations are intended to be included herein within the scope of this disclosure and protected by the following claims.

1. A system comprising:
at least one computing device comprising a processor and a memory; and
computer-executable instructions stored in the memory, wherein when executed by the processor, the instructions causes the at least one computing device to at least:
obtain a tree data structure of a system-level failure risk of a system plant, wherein a binary state failure probability of an internal node in the tree data structure is a function of its logic gate connection and its child nodes;
for a condition where the tree data structure has only independent nodes, compute a binary state failure probability of a failure event represented as a top node of the tree data structure;
for a condition where the tree data structure has multiple dependent chains having a common dependent node, evaluate the binary state failure probability of each dependent chain separately; and
output the binary state failure probability for the failure event represented as the top node of the tree data structure.

2. The system of claim 1, wherein for the condition where the tree data structure has only independent nodes, the binary state failure probability of the failure event represented as the top node of the tree data structure is computed based on the logic gate connection of the top node and the binary state failure probabilities of its child nodes.

3. The system of claim 1, wherein for the condition where the tree data structure has multiple dependent chains having the common dependent node, the evaluation of the binary state failure probability of each dependent claim comprises evaluating a linear function of the binary state failure probability of the common dependent node and computing the binary state failure probability of the failure event represented as the top node of the tree data structure.

4. The system of claim 3, wherein for the condition where the tree data structure has multiple dependent chains having the common dependent node, the binary state failure probability of the failure event represented as the top node of the tree data structure is computed by considering an intersection between the multiple dependent chains in terms of the common dependent node.

5. The system of claim 1, wherein for the condition where the tree data structure has multiple dependent chains having the common dependent node, the binary state failure probability of the failure event represented as the top node of the tree data structure is computed by calculating coefficients of a linear expression for each dependent chain's binary state failure probability and using the calculated coefficients to determine coefficients of the linear expression for the binary state failure probability of the top node and estimating the binary state failure probability of the top node based on the coefficients of the linear expression for the binary state failure probability of the top node and the binary state failure probability of the common dependent node.

6. The system of claim 1, wherein the instructions further cause the at least one computing device to convert a fault tree representation of the system-level failure risk of the system plant to the tree data structure.

7. The system of claim 6, wherein logic gates in the fault tree are converted into an input state and an output state in the tree data structure.

8. The system of claim 1, wherein the instructions further cause the at least one computing device to analyze the tree data structure and quantify one or more importance measures that provide a quantitative measure to identify basic events that contribute the most to the a system-level failure risk of the system plant

9. The system of claim 8, wherein the one or more importance measures comprise Risk Increase Ratio (RIR), Risk Reduction Ratio (RRR), Birnbaum Importance (BI), and Fussell-Vesely (FV) measurements.

10. A method comprising:
obtaining, via at least one of one or more computing devices, a tree data structure of a system-level failure risk of a system plant, wherein a binary state failure probability of an internal node in the tree data structure is a function of its logic gate connection and its child nodes;
for a condition where the tree data structure has only independent nodes, computing, via at least one of the one or more computing devices, a binary state failure probability of a failure event represented as a top node of the tree data structure;
for a condition where the tree data structure has multiple dependent chains having a common dependent node, evaluating, via at least one of the one or more computing devices, the binary state failure probability of each dependent chain separately; and
outputting, via at least one of the one or more computing devices, the binary state failure probability for the failure event represented as the top node of the tree data structure.

11. The method of claim 10, wherein for the condition where the tree data structure has only independent nodes, the binary state failure probability of the failure event represented as the top node of the tree data structure is computed based on the logic gate connection of the top node and the binary state failure probabilities of its child nodes.

12. The method of claim 10, wherein for the condition where the tree data structure has multiple dependent chains having the common dependent node, the evaluation of the binary state failure probability of each dependent claim comprises evaluating a linear function of the binary state failure probability of the common dependent node and computing the binary state failure probability of the failure event represented as the top node of the tree data structure.

13. The method of claim 12, wherein for the condition where the tree data structure has multiple dependent chains having the common dependent node, the binary state failure probability of the failure event represented as the top node of the tree data structure is computed by considering an intersection between the multiple dependent chains in terms of the common dependent node.

14. The method of claim 10, wherein for the condition where the tree data structure has multiple dependent chains having the common dependent node, the binary state failure probability of the failure event represented as the top node of the tree data structure is computed by calculating coefficients of a linear expression for each dependent chain's binary state failure probability and using the calculated coefficients to determine coefficients of the linear expression for the binary state failure probability of the top node and estimating the binary state failure probability of the top node based on the coefficients of the linear expression for the binary state failure probability of the top node and the binary state failure probability of the common dependent node.

15. The method of claim 10, wherein the instructions further cause the at least one computing device to convert a fault tree representation of the system-level failure risk of the system plant to the tree data structure.

16. The method of claim 10, wherein the instructions further cause the at least one computing device to analyze the tree data structure and quantify one or more importance measures that provide a quantitative measure to identify basic events that contribute the most to the a system-level failure risk of the system plant.

17. A non-transitory computer-readable medium embodying a program executable in at least one computing device, wherein when executed the program causes the at least one computing device to at least:
obtain a tree data structure of a system-level failure risk of a system plant, wherein a binary state failure probability of an internal node in the tree data structure is a function of its logic gate connection and its child nodes;
for a condition where the tree data structure has only independent nodes, compute a binary state failure probability of a failure event represented as a top node of the tree data structure;
for a condition where the tree data structure has multiple dependent chains having a common dependent node, evaluate the binary state failure probability of each dependent chain separately; and
output the binary state failure probability for the failure event represented as the top node of the tree data structure.

18. The non-transitory computer-readable medium of claim 17, wherein for the condition where the tree data structure has only independent nodes, the binary state failure probability of the failure event represented as the top node of the tree data structure is computed based on the logic gate connection of the top node and the binary state failure probabilities of its child nodes.

19. The non-transitory computer-readable medium of claim 17, wherein for the condition where the tree data structure has multiple dependent chains having the common dependent node, the evaluation of the binary state failure probability of each dependent claim comprises evaluating a linear function of the binary state failure probability of the common dependent node and computing the binary state failure probability of the failure event represented as the top node of the tree data structure.

20. The non-transitory computer-readable medium of claim 19, wherein for the condition where the tree data structure has multiple dependent chains having the common dependent node, the binary state failure probability of the failure event represented as the top node of the tree data structure is computed by considering an intersection between the multiple dependent chains in terms of the common dependent node.
